(19) United States
(12) Patent Application Publication
(10) Pub. No.: US 2021/0182873 A1
(43) Pub. Date: Jun. 17, 2021

(54) METHOD AND SYSTEM FOR DETECTING AND ANALYZING ANOMALIES

(71) Applicants: Ulrich LANG, San Diego, CA (US); Rudolf SCHREINER, Falkensee (DE)

(72) Inventors: Ulrich LANG, San Diego, CA (US); Rudolf SCHREINER, Falkensee (DE)

(21) Appl. No.: 17/031,198

(22) Filed: Sep. 24, 2020

Related U.S. Application Data
(60) Provisional application No. 62/905,300, filed on Sep. 24, 2019.
(60) Provisional application No. 62/933,963, filed on Nov. 11, 2019.
(60) Provisional application No. 63/055,229, filed on Jul. 22, 2020.

(51) Int. Cl. G06Q 30/00; G06Q 30/06; G06K 9/62; G06F 40/20; G06N 20/00

(52) U.S. Cl. CPC G06Q 30/0185; G06Q 30/0627; G06N 20/00; G06F 40/20; G06K 9/627

(57) ABSTRACT

Method and system for automating analyzing anomalies of an item for which no golden reference item is available, by using reference information, wherein the golden reference item is a known non-abnormal instance of an analyzed assembly, includes loading from a data storage, a memory, or via a communication, or user entry, item information of an analyzed item to be analyzed to be either expected or abnormal; loading reference information about the analyzed item; preprocessing both of the item information and the reference information to facilitate analysis; analyzing the item information and the reference information to determine a result that indicates whether elements of the item are confirmed by the reference information to be expected or abnormal; generating an output data with the result; and storing the output data pertaining to the result in a memory.

This application claims priority to U.S. Provisional Application Nos. 62/905,300 entitled “Method and System for Analyzing Images, for example microelectronics devices, circuit boards etc.”, 62/933,963 entitled “Method and System for Analyzing Images, for example microelectronics devices, circuit boards etc.”, and 63/055,229 entitled “Method and System for Differential Stimulation”, which were filed on Sep. 24, 2019, Nov. 11, 2019, and Jul. 22, 2020 respectively, and which are all incorporated herein by reference.

### BACKGROUND OF THE INVENTION

### 1. Field of the Invention

An embodiment of the invention relates to Machine Learning within a computer system, and more particularly to checking baselines for Machine Learning based anomalies detection system.

An embodiment of the invention comprises a novel, innovative and comprehensive end-to-end solution that is practical, effective, agile and cost-effective for microelectronics anomalies detection around provenance, trust and assurance.

### 2. Description of the Related Art

The following background section explains the multiple aspects of anomaly detection related to the present invention,

### Anomalies Detection Using Machine Learning

A common application of Machine Learning (ML) systems is anomalies detection, the detection of deviations from a normal systems behavior. Anomalies detection system are for example, but not limited, used for the detection of intrusions, policy violations and other security incidents in IT systems. Here, the ML system is trained to a baseline of normal behavior of the IT system, for example, but not limited to usage and communications patterns. If the ML system detects a deviation from the behavior trained as normal, an anomaly, for example an intrusion, is indicated.

In the detection of anomalies based on Machine Learning, the correctness of the baseline of known good behavior is a major issue. The baseline can be a limited set of input data, considered as data describing normal behavior. Or, in other implementations of anomalies detection systems, deviations from all prior inputs are considered anomalies. This can be seen as incremental learning on all prior input as training material.

The issue addressed is now the correctness of this training material describing normal systems behavior. In the above example of an intrusion detection system, the baseline, which is considered as normal, might already contain anomalies, for example because this system is already attacked, unknown to the operators. In practice, it is very common to install anomalies-detection based-intrusion detection systems (IDS) without considering this issue. This means that the anomalies detection system is already trained to consider intrusions or policy violations as the normal behavior of the system, and does not anymore detect similar, additional anomalies during runtime. Therefore, the current anomalies-based intrusion, policy violation and incident detection systems are only reliably applicable to complete new system installations.

Other relevant applications of the invention are IoT applications and Cyber Physical Systems (CPS), for example Condition Based Maintenance (CBM/CBM+) systems, where, in layterms, the state of a complex system is derived from sensor data. For example, from temperature, noise and vibration sensors, the condition of a complex engine is derived, for example, whether maintenance is required. This is often done using an anomalies detection, e.g. if the vibrations and temperature are higher than normal, a signal is generated. The challenge now is to detect the higher than normal as early as possible, and especially to check whether the normal of a specific engine is already higher than it should be, because, for example, a bearing does not meet the requirements.

### Supply Chain Anomalies Detection for Microelectronics

Numerous threats enter the microelectronics supply chain, including questionable provenance, trust and assurance issues, malicious threats etc., for example: malicious injection (e.g. of “kill-switch” features); counterfeit parts (which often do not meet QA), such as chips; modified repurposed/recycled parts (e.g. relabeled chips of lower quality, e.g. not meeting MIL-SPEC), such as chips; replaced devices (e.g. motherboard completely replaced); additional or missing parts (e.g. on PCBs) etc.

Determining whether these and other issues are the case is particularly challenging for commercial of the shelf (COTS) microelectronics, vs. controlled supply chains such as for military weapons systems. This is because for COTS microelectronics, specifications, bill of materials (BOMs), expected sensor readings, supply chain traces etc. are usually not available. Additionally, “golden units” (=known good reference PCBs/parts used for comparison purposes. (This is related to supply chain risk analysis, but there are other supply chain risks, such as loss of production, production delays, financial uncertainty etc.)

Conventional approaches to analyzing supply chain anomalies (risks) are slow, expensive, and often manual. As a workaround, supply chain risk management often involves vetting/approving the vendor vs. actually analyzing the supplied products; it also often involves manual analysis/testing; sometimes also the customization of general-purpose business intelligence/analytics tools; and sometimes consultants are brought into an organization to carry out manual analysis.

Analyzing microelectronics supply chain provenance/assurance/risks needs to be done in numerous job functions and tasks, for example: supply chain risk managers need to know about risks facing the organization; when outside devices are brought into a secure facility, analysts need to determine whether the device is safe to be used on site; warehouse/logistics staff need to determine whether received products pose a risk or not; etc.

### SUMMARY OF THE INVENTION

According to an aspect of the present invention, a method of automating analyzing anomalies of at least one item for which no golden reference item is available, by using reference information, wherein the golden reference item is a known non-abnormal instance of an analyzed assembly, may comprise:

loading, via a processor, from a data storage, a memory, or via a communication, or user entry, at least one item information of an analyzed item to be analyzed to be either expected or abnormal;
loading, via the processor, at least one reference information about the analyzed item;
preprocessing, via the processor, both of the at least one item information and the at least one reference information to facilitate analysis;
analyzing, via the processor, the at least one item information and the at least one reference information to determine at least one result that indicates whether elements of the at least one item are confirmed by the at least one reference information to be expected or abnormal;
generating, via the processor, an output data with the at least one result; and
storing, via the processor, the output data pertaining to the at least one result in a memory.

The analyzed item may comprise at least one of a device, microelectronics, a printed circuit board, a medical supplies item, a fashion item, or pharmaceutical substances. The at least one item information may comprise at least one of a make, a model, a serial, a revision, a type, an origin, images, visual images, photographs, non-visual images, x-ray images, terahertz images, electromagnetic images, electroscopic image, specifications, datasheets, item literature, shopping reviews, counterfeit databases, item databases, shop listings, social media information, news media information, or a bill of materials.

The at least one reference information may be loaded from a local storage or memory, a remote network location, or a search engine. The at least one reference information may comprise at least one of a make, a model, a serial, a revision, a type, an origin, images, visual images, photos, non-visual images, x-ray images, terahertz images, electromagnetic images, electroscopic image, specifications, datasheets, item literature, shopping reviews, counterfeit databases, item databases, shop listings, social media information, news media information, or a bill of materials.

Both of the at least one item information and the at least one reference information may be processed by performing one or more of Optical Character Recognition (OCR), text extraction, Natural Language Processing (NLP), image processing, computer vision, image object recognition, textual lookups, textual resolving, and textual auto-complete on both of the at least one item information and the at least one reference information or by validating the accuracy of the at least one item information and the at least one reference information.

The at least one item information and the at least one reference information may be analyzed by determining: confidence in identification, source, specification; risk, trust and compliance levels; whether a bill of materials of the analyzed item is as expected; whether an image of the analyzed item matches with the at least one reference information; known issues with the analyzed item; known issues with the bill of materials of the analyzed item. The at least one item information and the at least one reference information may be analyzed by performing automated and manual analysis on the at least one item information and the at least one reference information.

The output data with the at least one result may be generated by performing one or more of user interface output, report, dashboard, alarm, and notification. The output data with the at least one result may be stored to a local memory or storage, or transmitted to a remote location and storing the output data to a memory at the remote location.

In another embodiment, a system for automating analyzing anomalies of at least one item for which no golden reference item is available, by using reference information, wherein the golden reference item is a known non-abnormal instance of an analyzed assembly, may comprise a processor that is configured to:

load, from a data storage, a memory, or via a communication, or user entry, at least one item information of an analyzed item to be analyzed to be either expected or abnormal;
load at least one reference information about the analyzed item;
preprocess both of the at least one item information and the at least one reference information to facilitate analysis;
analyze the at least one item information and the at least one reference information to determine at least one result that indicates whether elements of the at least one item are confirmed by the at least one reference information to be expected or abnormal;
generate an output data with the at least one result; and
store the output data pertaining to the at least one result in a memory.

The analyzed item may include at least one of a device, microelectronics, a printed circuit board, a medical supplies item, a fashion item, or pharmaceutical substances. The at least one item information may comprise at least one of a make, a model, a serial, a revision, a type, an origin, images, visual images, photographs, non-visual images, x-ray images, terahertz images, electromagnetic images, electroscopic image, specifications, datasheets, item literature, shopping reviews, counterfeit databases, item databases, shop listings, social media information, news media information, or a bill of materials. The at least one reference information may be loaded from a local storage or memory, a remote network location, or a search engine.

The at least one reference information may comprise at least one of a make, a model, a serial, a revision, a type, an origin, images, visual images, photos, non-visual images, x-ray images, terahertz images, electromagnetic images, electroscopic image, specifications, datasheets, item literature, shopping reviews, counterfeit databases, item databases, shop listings, social media information, news media information, or a bill of materials.

The processor may preprocess both of the at least one item information and the at least one reference information by performing one or more of Optical Character Recognition (OCR), text extraction, Natural Language Processing (NLP), image processing, computer vision, image object recognition, textual lookups, textual resolving, and textual auto-complete on both of the at least one item information and the at least one reference information or by validating the accuracy of the at least one item information and the at least one reference information.

The processor may analyze the at least one item information and the at least one reference information by determining: confidence in identification, source, specification; risk, trust and compliance levels; whether a bill of materials of the analyzed item is as expected; whether an image of the analyzed item matches with the at least one reference information; known issues with the analyzed item; known issues with the bill of materials of the analyzed item. The processor may analyze the at least one item information and the at least one reference information by performing automated and manual analysis on the at least one item information and the at least one reference information.

The processor may generate the output data with the at least one result by performing one or more of user interface output, report, dashboard, alarm, and notification. The processor may store the output data with the at least one result by storing the output data to a local memory or storage, or transmitting output data to a remote location and storing the output data to a memory at the remote location.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 is a diagram that shows an example machine learning based anomalies detection system (algorithm 1), with example steps involved in checking a baseline for an anomalies-detection-based system for anomalies already hidden in the baseline data set, based on checking the training success of a merged data set.

FIG. 2 is a diagram that shows an example machine learning based anomalies detection system (algorithm 2) with example steps involved in checking a baseline for an anomalies detection system for anomalies already hidden in the baseline data set, for a pre-trained anomalies detection system.

FIG. 3 shows diagram of a reference-information-based anomaly analysis system;

FIG. 4 shows an example image result obtained by an example implementation of a reference-information-based anomaly analysis system.

FIG. 5 shows an example PCB image down-select feature of an example implementation of a reference-information-based anomaly analysis system.

FIG. 6 shows an example PCB image text extraction result of an example implementation of a reference-information-based anomaly analysis system.

FIG. 7 shows an example side-by-side physical/reference BOM editor of an example implementation of a reference-information-based anomaly analysis system.

FIG. 8 shows an example BOM editor with PCB image containing geo-pins of an example implementation of a reference-information-based anomaly analysis system.

FIG. 9 shows a diagram of an example of a mock data graph of a reference-information-based anomaly analysis system.

FIG. 10 shows an example of a graph database (excerpt) of a reference-information-based anomaly analysis system.

FIG. 11 shows an example report except that compares between physical and reference BOMs in an example implementation of a reference-information-based anomaly analysis system.

FIG. 12 shows an example report except with part details in an example implementation of a reference-information-based anomaly analysis system.

FIG. 13 shows an example of a manual analysis feature and report excerpt in an example implementation of a reference-information-based anomaly analysis system.

FIG. 14 shows a different depiction of the diagram in FIG. 3 of a reference-information-based anomaly analysis system

### DETAILED DESCRIPTION

The words “exemplary” and/or “example” are used herein to mean “serving as an example, instance, or illustration.” Any embodiment described herein as “exemplary” and/or “example” is not necessarily to be construed as preferred or advantageous over other embodiments. Likewise, the term “embodiments of the invention” does not require that all embodiments of the invention include the discussed feature, advantage or mode of operation.

Further, many embodiments are described in terms of sequences of actions to be performed by, for example, elements of a computing device. It will be recognized that various actions described herein can be performed by specific circuits (e.g., application specific integrated circuits (ASICs), Field Programmable Gate Arrays (FPGA), Graphics Processing Units (GPU)), by program instructions being executed by one or more processors, or by a combination of both. Additionally, these sequences of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

A method and system is illustrated for checking training data for supervised learning and for checking whether the baseline for an anomalies detection system already contains anomalies, and for automatically determining whether microelectronics contain anomalies based on collected and analyzed reference information.

### Terminology

For this specification, terms are defined informally as follows:
Provenance means the source of microelectronics parts, including the supply chain. The supply chain starts at the “foundry” and ends at the customer, with part manufacturers, circuit board manufacturers, sellers/resellers etc. in between. In this invention's context, provenance also indirectly relates to the question whether a PCB (printed circuit board) or part comes from the expected source (esp. manufacturer), and has not been tampered with, replaced, includes additional parts or misses parts compared to the specification. Trust is related to provenance and means confidence that PCBs or parts operate as expected and/or specified, and do not have any missing/changed/added etc. features. Assurance is the level of confidence that a PCB or part can be trusted and has the expected provenance.

### Embodiment of a Machine Learning Based Anomalies Detection System

### Baseline Analysis Through Stimulation

An embodiment of the present invention is directed to a method to check baselines of anomalies detection systems for hidden anomalies. For example, in operational IT systems, the baseline for an anomalies-detection-based intrusion detection might already include observations of attacks unknown to the system operators. In practice, this is not uncommon. If this baseline is used to train an anomalies detection system, the intrusion detection system would be trained to consider the attacks as normal behavior, and would not be able to detect them or similar attacks. An embodiment of the invention allows now to detect in the baseline such observations indicating attacks. It therefore allows to establish trust in the correctness of the baseline, or to find prior attacks.

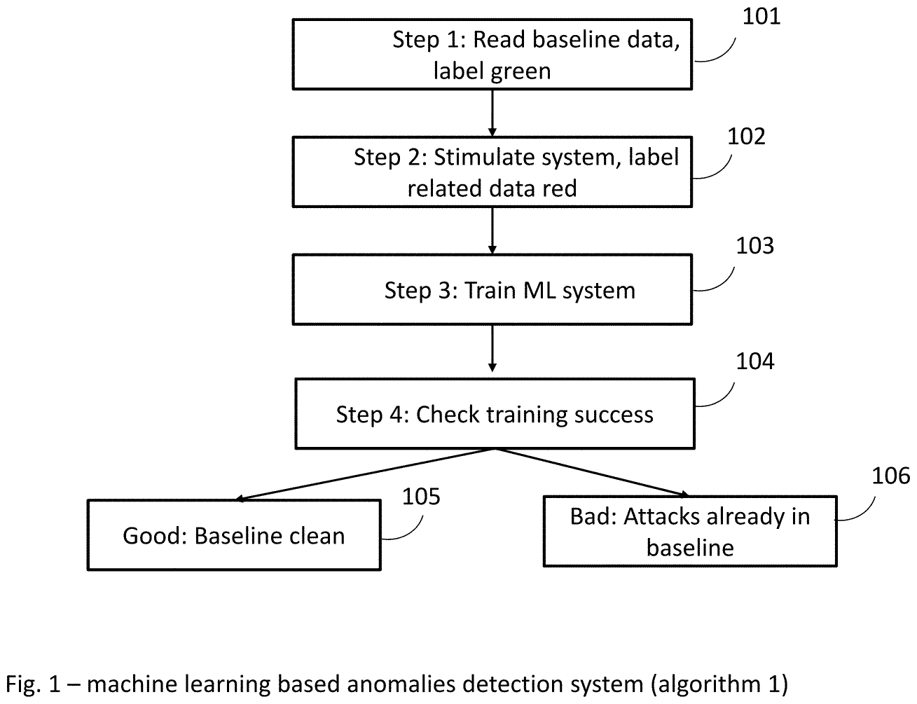

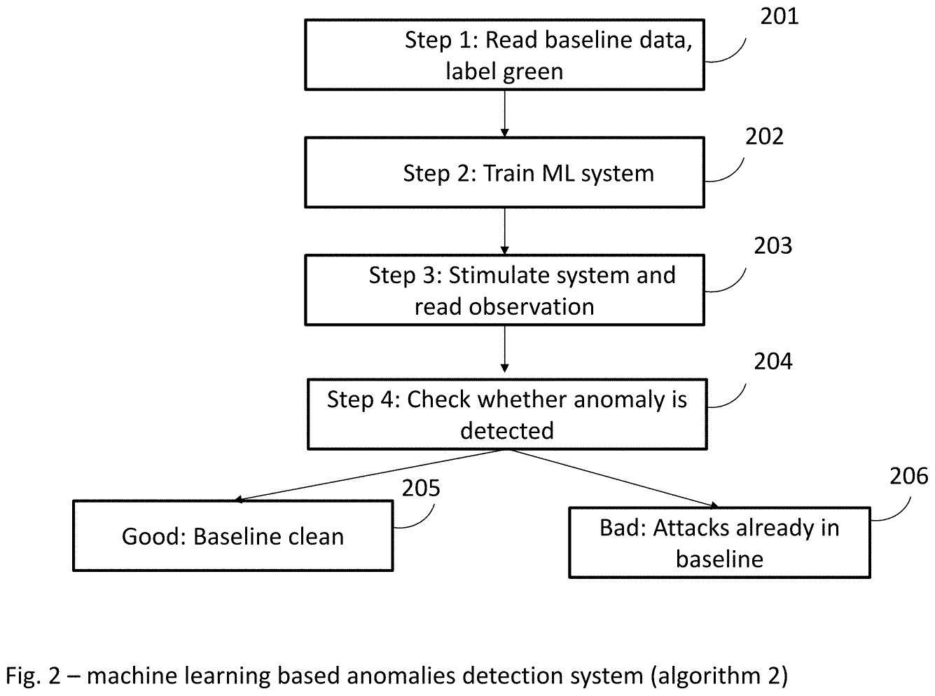

The present invention checks the existence of a potential anomaly in the baseline by application of one of the two following algorithms, as shown in FIG. 1 and FIG. 2.

In step 101 of algorithm 1 of the embodiment of the invention (FIG. 1), the baseline to check for anomalies is read into the ML system. The baseline is generated by observing the system, for example, but not limited to, an IT system. This includes, for example, but not limited to, observation and storing of the network traffic, of system logging information and so on. The objective of the invention is to find out whether the observations already contain anomalies, unknown to the system operator. The whole baseline input data is labeled as green, normal data, and the fact that this label is incorrect for the undetected anomalies is accepted.

The ML system uses classifiers, including for example, but not limited to Support Vector Machine or decisions trees, or Artificial Neural Networks (ANN), for example, but not limited to Deep Neural Networks (DNN), Convolutional Neural Networks (CNN), Recurrent Neural Networks (RNN) or autoencoders, or combinations of them.

In step 102, training data is intentionally generated with anomalies. For this purpose, the system, for example, but not limited to, the operational target IT system is stimulated, in order to generate anomalies. This includes, for example, but not limited to, in an IT intrusion detection system, running attacks against the target system. The attacks can be done manually or automated, using scripts or any other attack control mechanism. The attacks also might not be limited to the exploitation of vulnerabilities, but also include network exploration, or data access or modification. In addition, it is also possible not to stimulate the IT system to protect, but a similar system, or to generate the data by any other means. This includes, but is not limited to, simulation or any kind of algorithm generation. In other anomalies detection system, the anomalies training data might, for example, but not limited to, generated with physical models, for example, but not limited to, using MatLab/Simulink, OpenModelica or any other simulation software. It is also supported to reuse anomalies data obtained from operational system. All related training data is labeled as abnormal, or red, traffic. This step can be done for an individual type of anomaly, or a set of anomalies. It is especially important to stress that the training set labeled as anomaly is not only used as the direct stimulus data, or the direct system response of the stimulus. For example, but not limited to an intrusion detection system, the exploit itself is not considered only as training data marked as anomaly. In the invention, first of all, the stimulus is made as broad as possible, for example, but not limited to, and complete attacks are executed with, for example, but not limited to, exploration, accessing and modifying of data. Secondly, as much as possible data correlated to the stimulus, including higher order correlation, is captured. This includes, but is not limited to, power consumption, heat generation, radio emanations, other physical observations like vibrations and so on.

In step 103, the ML based anomalies detection system is trained using the data sets of step 101 and step 102, according the state of the art.

In step 104, the training success is evaluated into either a clean baseline (105) or attacks already in the baseline (106). The key of the invention is the fact that an anomaly, for example an intrusion, which is already in the baseline data set (of step 101) and incorrectly marked as normal system behavior, and an anomaly in data set of the stimulated system (of step 102), which is correctly marked as anomaly, reduce the training success and increase the error rate of the training.

This is similar to image recognition: There is a set of images of dogs, correctly labeled as dogs, and a set of birds, correctly labeled of birds. If a training and evaluation are not performed, based on a merging of both data sets, it is expected that the resulting image recognition system works well, in other words, that the training is successful. On the other hand, if there is a set of images of dogs and birds, all labeled as dogs, and a set of birds, all labeled as birds, it is seen that the training is less successful, because man birds are labeled as dogs. Therefore, it is possible to derive that the training set is not correct.

Algorithm 2 (FIG. 2) of the invention allows to check pre-trained ML based anomalies detection systems. For illustration, the training process is illustrated in the algorithm. In contrast to algorithm 1, the target system or an (almost) identical copy is directly worked, and also anomalies are supported at running, and at already deployed anomalies detection system.

In step 201, the baseline observations are read and marked as normal, green data.

In step 202, the ML based anomalies detection system is trained with the data from step 201.

In step 203, as described above, the target system is stimulated and the observed data is fed into the ML based anomalies detection system. But in this case now, this data is not used as training data, as above, but the system decides, based on the training from step 202, with the data from step 201, whether the observation is an anomaly.

In step 204, it is checked as to whether the ML based anomalies detection system indicates the data observed in step 203 is classified as an anomaly, or not. If it was classified as anomaly, it is understood that it was not already in the baseline data (205). If it was not classified as anomaly, it is understood that this specific anomaly is already in the baseline data, labeled as normal system behavior (206). Therefore, similar to the algorithm 1 described above, it is able to check the baseline for hidden anomalies. The invention can be applied to any kind of anomalies detection system, if, by any means, it is possible to generate anomalies data for training. A key aspect of the invention is the consideration of not only first order observations, for example, or not limited to, in an intrusion detection system the exploit data, but also observation with a higher order correlation, for example, but not limited to acoustic, thermal and electromagnetic emanations, vibrations, power consumption, system load, performance degradations and so on. Potential applications include, beyond the already mentioned detection of intrusions, policy violations and incidents in IT systems, and maintenance (e.g. Condition Based Monitoring, predictive maintenance etc.) also for example, but not limited to, fraud detection, Internet of Things (IoT) and Cyber Physical Systems (CPS) (physical access control, air condition and facility management), or intelligence and predictive policing, civil and military early warning systems and so on.

### Embodiment of Reference Information Based Anomalies Analysis System, e.g. for Analyzing Microelectronics Provenance, Trust and Assurance

An embodiment of the present invention is an anomalies analysis system (in the following referred to as “the system”) focused on automating significant parts of the process of analyzing anomalies for microelectronics. Example analysis tasks, one or more of which are automated, involve:
visually inspecting PCBs to determine the bill of materials (BOM), i.e. which parts are on a Printed Circuit Board (PCB)
looking up relevant information about PCBs and parts, which often involves searching, aggregating and analyzing large parts of siloed data. Humans are slow and not good at such tasks that involve sifting through a lot of data. For example, a relevant data point for a part could be buried in a PDF specification buried on some manufacturer as an embedded image showing a schematic of the PCB with some part specifications. Finding this data point is akin to finding the “needle in the haystack”.
comparing identified information (e.g. visual or other sensor images, BOM lists etc.) with reference information—which is especially hard if reference information is found by some sources in overlapping, redundant error-prone, sources (it is easier if a manufacturer spec is available, as is for example the case for military or avionics specific microelectronics)
looking up known counterfeit information about PCBs and parts.
generating reports/documentation of the results of the analysis
etc.

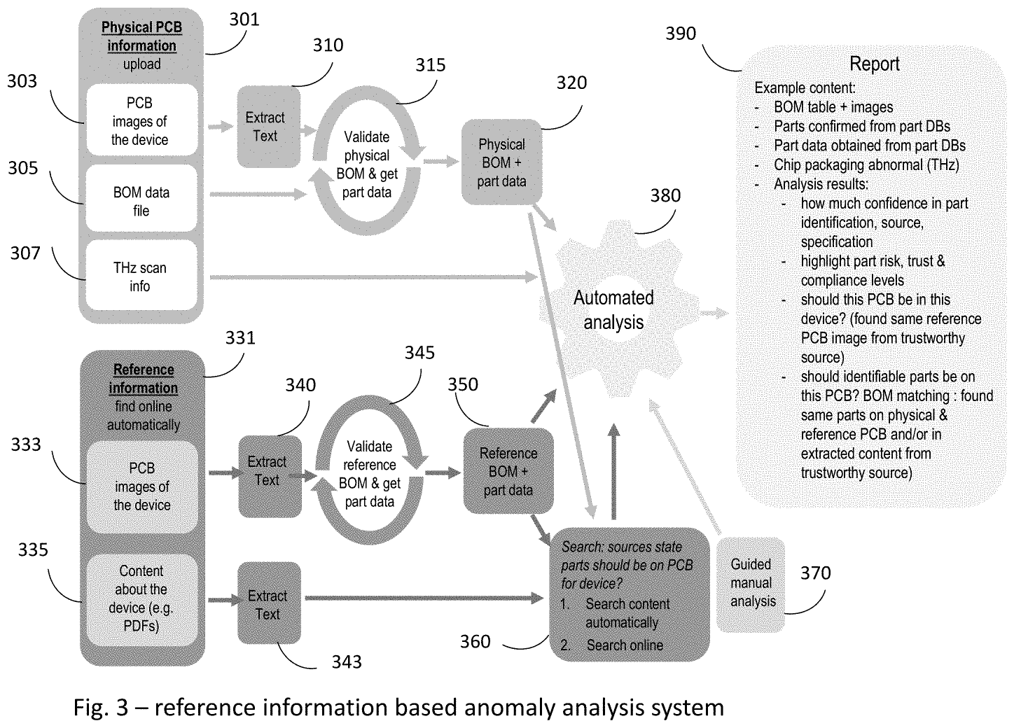

The following FIG. 3 illustrates an embodiment of the present invention where steps of the analysis process are automated. Note that while the specification refers to “steps”, these can also be components of a system (but may be aggregated in different ways). Also, the sequence of steps could be reordered in anyway, for example such that the total analysis time is minimized based on the dependencies between the steps. Also, steps could be omitted or added, and can be manual or automated. Furthermore, “user” can be an automated entity, e.g. interacting with the system via Application programming Interfaces (APIs).

### Assembly Information

In step 301, a user enters basic information about the device (“assembly”), e.g. make, model, into the system. In an embodiment, the system determines whether the device is already in the system or not, for example from a previous analysis, or from procurement data (esp. if the devices has been procured using a procurement system, e.g. SAP), and loads existing data if available. In an embodiment of the system, a user also selects step 301 the existing/known product (e.g. by serial number) or enters basic product information (serial number etc.) (“assembly information”). Note that the assembly is often an entire device, e.g. router, graphics card, laptop, tablet, smartphone etc. An example would be “Linksys AC1750 router rev. X serial Y” (manufacturer, model, revision, serial number).

### Physical Information

In step 303, the user uploads one or more visual circuit board images of the device for which provenance/assurance needs to be analyzed into the system. In an embodiment of the invention, the device is a physical device in hand, while in another embodiment, the device may refer to information about a device (e.g. photos). In an embodiment, the user furthermore uploads (305) existing information about the Bill of Materials of the physical device, e.g. from prior out-of-band analysis. In addition to one or more visual images, the user can also include other images (307), such as electromagnetic, terahertz (step 106, optional), x-ray etc. In an embodiment, such imaging is done in layers, e.g. top of chips, inside chips, PCB print (top), copper layers, PCB print (bottom), inside chips (bottom), top of chips (bottom).

### Reference Information

“Reference information” is needed to determine whether the analyzed PCB/BOM exhibits any anomalies. “Golden unit” or “golden reference item” is commonly referred to as a known good (i.e. not abnormal) instance of the analyzed assembly, and is used to compare an assembly with another known good assembly during analysis.

If explicit “golden unit” reference information about the assembly is available, the system loads that golden unit reference information.

However, in many cases (esp. for Commercial-Off-The-Shelf—COTS—assemblies), no golden units or other detailed specification information is available to the user or the system. An important aspect of the present invention is that in such cases where no golden unit reference information is available, an embodiment of the system attempts to automatically gather (331) reference information from not explicitly specified/known online sources.

In step 113, an embodiment of the system searches information sources (incl. the internet) for “reference images” of printed circuit boards (PCBs), for example using online search APIs (e.g. Google Custom Search)—for example searching for (potentially combinations of) the name of the assembly (“Linksys router xy”) and suitable search terms “circuit board” (or similar). The search returns links to images.

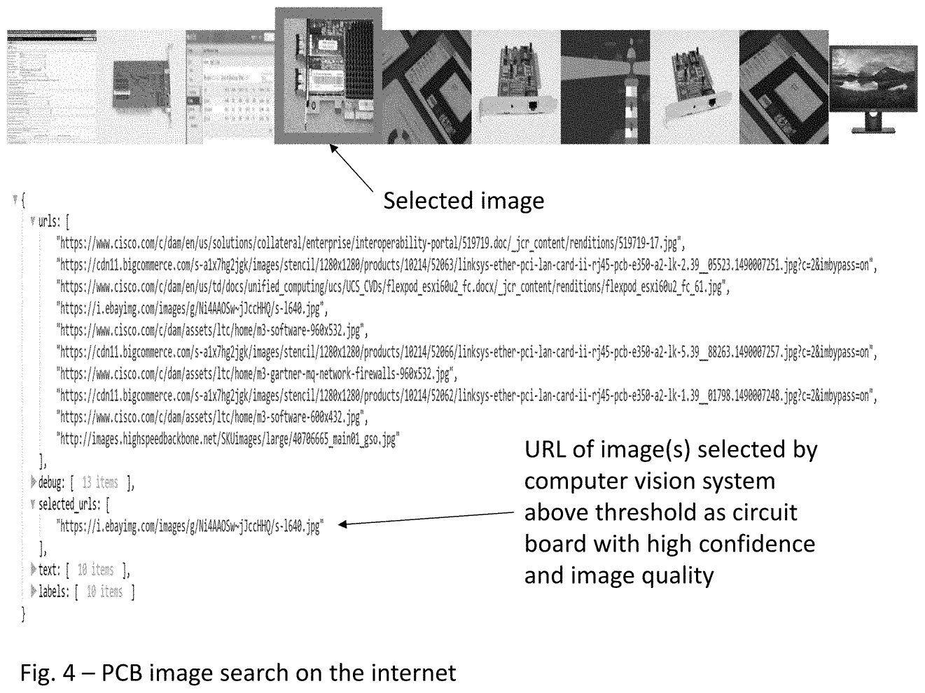

Also within step 113, an embodiment of the system then determines whether the image actually shows a circuit board or not. This can for example be done using computer vision based on machine learning. This can for example be implemented using computer vision using a computer vision API (e.g. Google Vision API) or well-known deep learning techniques (or TensorFlow with retrained ImageNet neural net, for example), to perform image object recognition/classification. An exemplary result of this process is a list of labels for each image with a probability score. A filter is applied that is hard-coded or configurable, e.g. accept all images that have the labels “circuit board”, “microelectronics”, “computer component” (or similar) above a certain probability (e.g. 90%). Additional filters and rankings are optionally applied, for example dropping images below a certain size, and ordering images by size (assuming larger images are more detailed). The result is a down-selected list of circuit board images of the assembly found online. FIG. 4 illustrates an example implementation using Google Vision API—for example (using Google) URLs for the query “Linksys S-666 circuit board”. As depicted, out of the 10 returned images, only one meets the requirements (circuit board depicted, minimum size etc.).

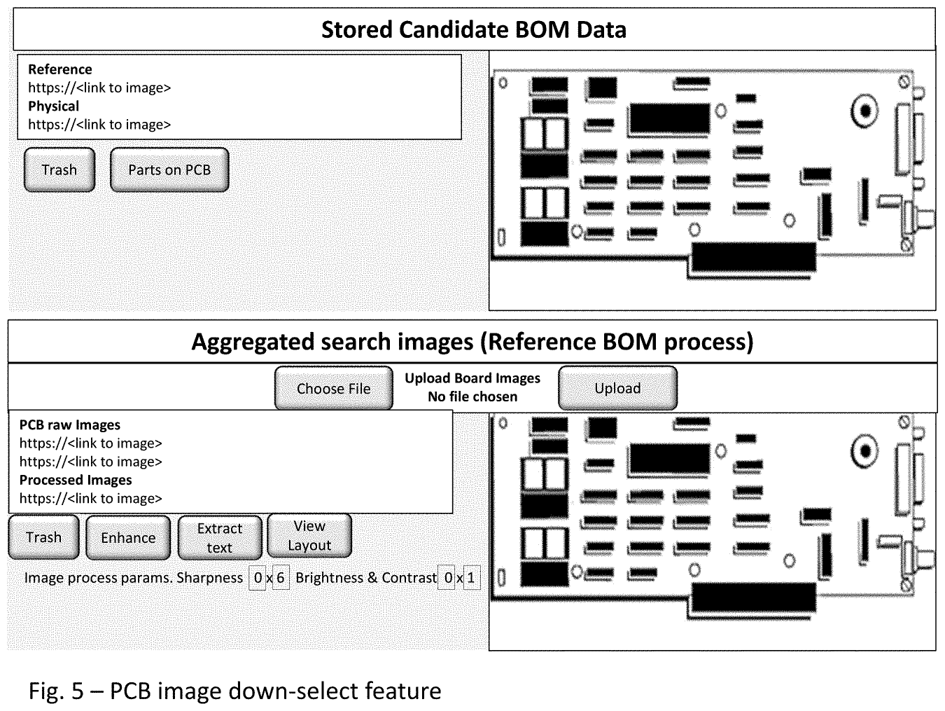

In an embodiment of the system, the user can optionally examine and manually down select images. FIG. 5 illustrates an example implementation of such a down-select feature.

In step 335, the system searches data sources (e.g. the internet) for reference specifications, datasheets etc. for the assembly. This can for example be implement using online search APIs (e.g. Google Custom Search with search parameter “filetype:pdf” to get only PDFs of specifications). In the case of Google Custom Search, this step returns URLs of PDFs online (in other implementations, the PDFs themselves could for example be returned). In this step 335, the system can efficiently construct a number of searches by combining the assembly information from step 301 with additional search terms such as e.g. “datasheet”, “specification”. Also within this step 335, in an embodiment of the system the user can optionally down-select assembly specifications to the relevant ones and store them.

### Reputation of Reference Information

An important aspect of the present invention is that the usefulness of the reference information depends on the reputation of the source. An embodiment of the system scores the reputation of the data sources for each data item (image, PDF etc.). This can be one by for example examining the domain name the document or image was obtained from. For example, if all reference information is obtained the web page of the manufacturer, then its reputation would be high. If it has been found on a webpage of unknown origin or from questionable sources (e.g. refurbished parts sellers), then its reputation may be low. Images from crowdsourced pages (e.g. Wikipedia, WikiDev etc.) could be considered medium reputation. The exact reputation ranking and threshold is an organizational decision.

If the system has found “reference” PCBs, it now has two kinds of information: physical image(s), e.g. uploaded by the user, and reference information, for example images and specifications found online and filtered for relevance. Otherwise it has only physical image(s).

### Text Extraction

In an embodiment of the system, the found sources from steps 301, 303, 305, 307, 331, 333, and 335 are prepared for searching, using automatic optical character recognition (OCR) and text extraction is applied to all identified documents, followed by a mechanism that allows searching across the documents (done in a later step). In step 310, text from PCB images from step 303 is extracted to create a BOM of the PCB(s), while in step 340, text from images from step 333 is extracted to create a BOM of the PCB(s).

In an embodiment of the system, text extraction using optical character recognition (OCR) is implemented using Apache Tika and Tesseract OCR, and/or Google Vision, Azure Vision etc. Note that many tools such as Google Vision API provides extracted text together with rectangular bounding boxes.

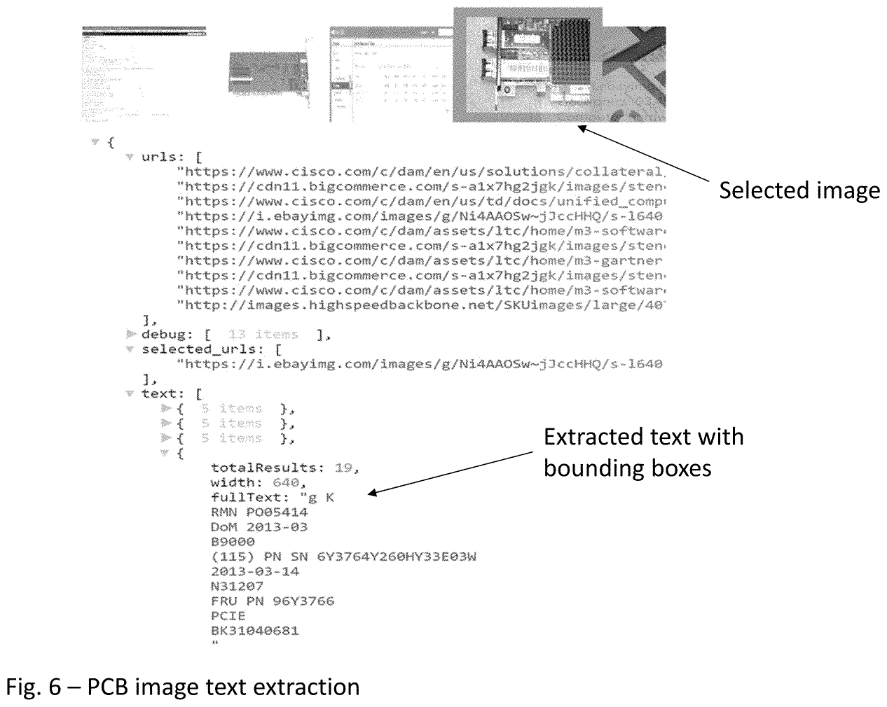

The result of the text extraction is a first (potentially not 100% correct) textual representation of the Bill of Material (BOM) of each PCB. Note that text extraction tools may also pick up markings on the circuit board itself (in addition to markings on the parts), such component classifiers, PCB manufacturer, serial numbers, revision numbers etc. FIG. 6 illustrates an example of a text extraction result (with bounding boxes provided in the return data).

As part of step 335, an embodiment of the system applies automated image processing can be applied to improve text extraction quality, for example adaptive sharpen and brightness/contrast adjustments. This can for example be achieved using well-known tools such as “ImageMagick”. The image processing service can for example be implemented as a URL replacement service, where an image or URL is sent to the server, and the server creates a local copy of the image. The server then provides a shorthand URL to the image back to the system, which then uses the link going forward instead of the original URL. For convenience, an implementation can include the image processing parameters as part of the URL or URL parameters (or in the request body, e.g. JSON). The benefit of making image processing parameters part of the URL is that it allows the system to dynamically create numerous processed images. For example, the original image from the shorthand link https://<IP>/img/ZGHJfgHGFFyrtrty gets changed by adding exemplary adaptive sharpen parameters (“as”) and brightness/contrast parameters (“bc”): /as0x1/bc10x05. Using this exemplary approach, processed images can be processed (esp. for text extraction) just like the original URLs but with automated image processing applied.

As part of step 335, an embodiment of the system combines text bounding boxes into logical larger text blocks. This feature is needed if the extracted text is split into more than one bounding box per part (e.g. 3 bounding boxes for a chip with 3 lines of text). In an embodiment of the system, a combining algorithm combines bounding boxes if they are either overlapping or within close proximity. In an embodiment, computer vision is used to trace edges of parts, followed by combining bounding boxes approximately contained within each part bounding box. In an embodiment, image object recognition (using machine learning computer vision systems that detect bounding boxes and/or masks, e.g. Mask RCNN) is used to detect parts the PCB image, allowing the association of geographically close text bounding boxes/masks with parts.

In an embodiment, the system now has produced preliminary physical and reference BOM tables.

In steps 315 and 345, an embodiment of the system then validates the physical and reference BOMs, by searching online data sources (e.g. part databases, internet search . . . ) for BOM line item text (and optionally substrings)—with the goal to validate and (if needed) resolve/auto-correct the found text to valid manufacturer and part information, optionally supporting searching for substrings and incomplete information to facilitate better matching, and for equivalent cross-manufacturer parts, helping identify that a (generic) part is the same as found in the online data but e.g. by a different manufacturer. In an embodiment, the system automatically correct editing issues using mapping tables, NLP, typo autocorrection approaches etc.

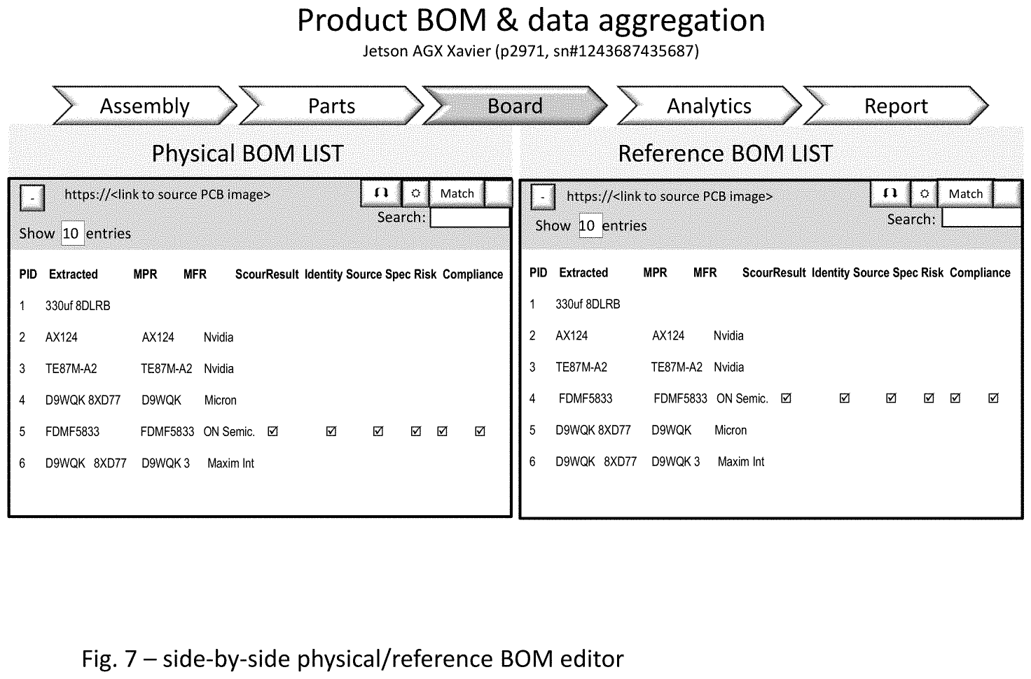

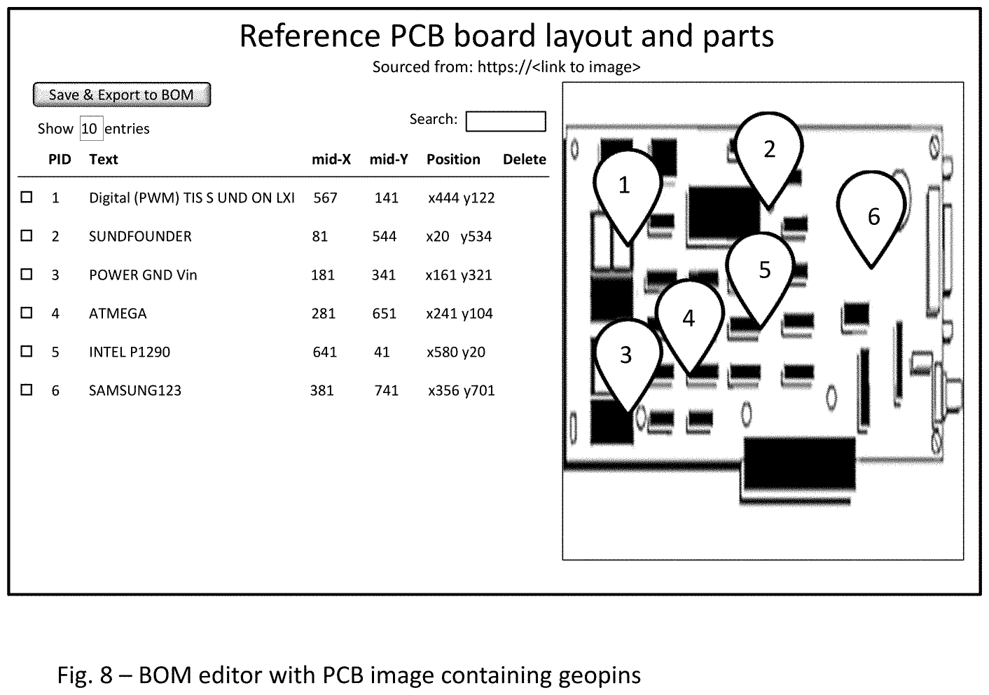

In an embodiment of the system (steps 315 and 345), the user optionally edits (e.g. correcting typos) the various BOM information returned from the text extraction, to ensure correctness. In an example implementation, this is done in a table where physical and reference BOMs are side-by side, allowing for easy editing (see example screenshot in FIG. 7). Editing may include visually exploring the PCB image and editing information (optionally with zoom functionality). The editor also allows the user to add new items (e.g. by clicking on the PCB image to add e.g. a new geo-pin for a BOM line item—see example in FIG. 8). Note that many image text extraction mechanisms (e.g. Google Vision) provide positional information, including the bounding box around text, enabling an embodiment of the system to show geo-pins of automatically determined BOM items on the associated part on the image, clickable to move between the pin and the matching BOM table row.

An embodiment of the system also includes a feature for (optional) rescanning of PCBs and BOM text (for type correction), allowing the user to iteratively arrive at a correct BOM table.

### Part Data Gathering

In steps 320 (for physical BOM) and 350 (for reference BOM), an embodiment of the system sends the BOM table (e.g. in JSON, CSV) or individual BOM line items to external data providers (e.g. part databases) who provide information about parts, including datasheets, images, counterfeit information, manufacturer information, county of origin etc. In an embodiment, the system maps the gathered data to a common taxonomy, allowing for consistent aggregation, analysis and reporting. In an embodiment, the system uses name resolution and error correction, e.g. typos in manufacturer names, and or resolves cross-manufacturer names.

Also in steps 320 (for physical BOM) and 350 (for reference BOM), an embodiment of the system, searches the (general) Internet for information one or more parts, e.g. using online search APIs (e.g. Google Custom Search API), gathering content related to a part, e.g. weblinks, documents, images etc. This search is done for the part, or for the part in the context of the assembly. The latter yields a smaller, more focused dataset. One purpose of this online part data search is to identify online sources discussing the part in the context of the assembly.

### Parts/Device Analysis

In step 360 an embodiment of the system searches the extracted text from step 343, identifying documents (or other processed content) that discusses one or more parts in the context of the assembly. One objective of this mechanism is to determine whether a part should be on a PCB for a particular assembly according to the reference information.

In an example implementation natural language processing (NLP) is used to determine the nature of the mentioning of the part and the assembly—for example with the purpose of automatically filtering out mentionings that are not relevant.

At this point, prior to step 380, all the data described so far is stored in the system. This may result in multiple alternatives and/or information points per BOM line item. In an embodiment of the system, the user can optionally (and for example iteratively) down-select and/or edit as needed. Note that storage may be distributed, for example part data may be stored in a part server and referenced (e.g. by URL), images and documents may be stored in an image or document server and referenced (e.g. by URL, file handle, processing job ID etc.).

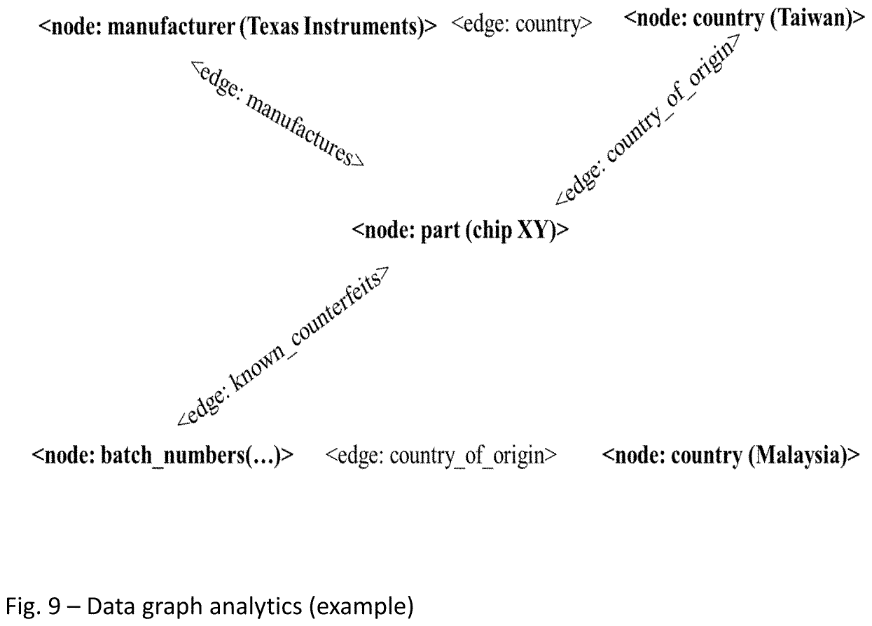

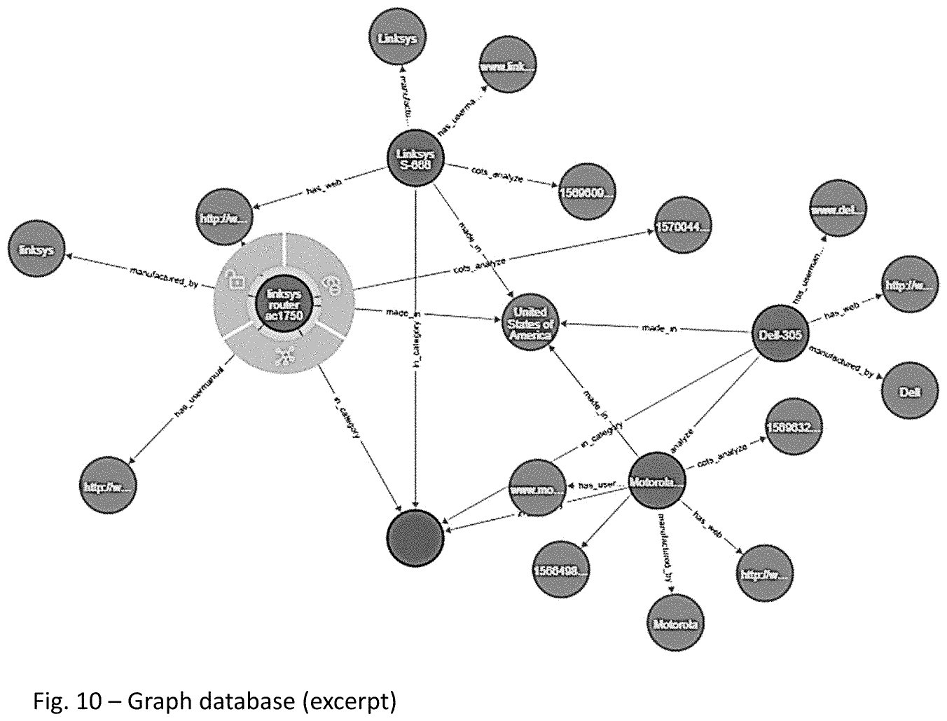

In an embodiment of the system, the data is stored in a graph database, and data aggregation and analysis include the automatic creation of a graph based on a unified taxonomy, allowing efficient and effective analysis. Graphs allow the explicit specification of relationships between nodes, illustrated by the (simplified mock) example depicted in FIG. 9 (in pseudo-notation): the analysis algorithm can traverse the graph for a specific part to determine that counterfeit parts can be identified reliably based on the country of origin stamp on the chip (mock example!) that the manufacturer only manufactures in the one specified country. FIG. 10 illustrates an excerpt of a data graph for a Linksys router stored in a graph database implementation (neo4j).

### Automated Analytics

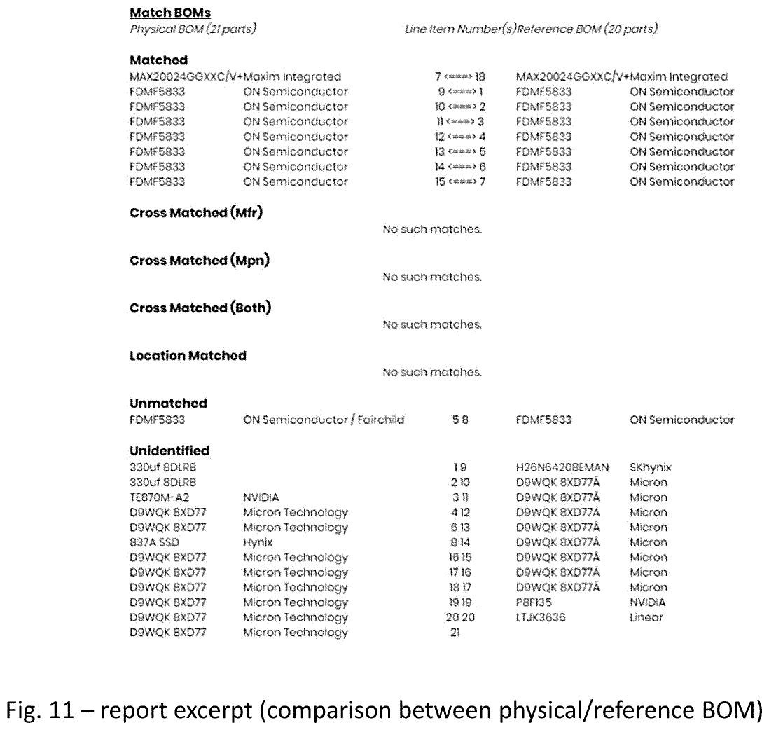

In step 380, an embodiment of the system carries out automated analytics, for example implemented as pluggable analytics software modules. For example:
if a terahertz/x-ray etc. image indicates a particular part packaging (plastic) for a particular manufacturer, but the chip markings (text) indicates a different manufacturer, this is an anomaly.
if the reference BOM (from a reputed source, e.g. manufacturer website) and the physical BOM do not match, i.e. differ about certain part, but the user confirmed that both devices/BCPs are the same revision, then this may increase the likelihood that the physical BOM is not as expected, and further analysis may be advisable. FIG. 11 illustrates a report result indicating matches/mismatches between physical and reference BOMs in an example implementation.
if a part identity or source (e.g. manufacturer) could not be identified from part databases, confidence is lowered because it is unknown
if no part specifications could be found, confidence is lowered because it is unknown
if known counterfeit or other supply risk information has been identified, confidence is lowered because it is unknown
if the PCB identity and revision could not be confirmed based on a reference PCB image from an acceptable reputational source, confidence is lowered because it is unknown
if documents or other content was found that state or imply that the part should be on the PCB or assembly, confidence for that part is increased.
if physical counterfeit or QA information has been found on a part (e.g. scratches, acetone test), confidence for that part is lowered.
if the analyzed item scan (visual or otherwise) exhibits differences compared to a reference item that indicate potential anomalies, using for example computer vision (e.g. machine learning) based anomaly detection, or for example scans of emanations or outputs of the item (e.g. electromagnetic, input/output, radio waves, power usage etc.)

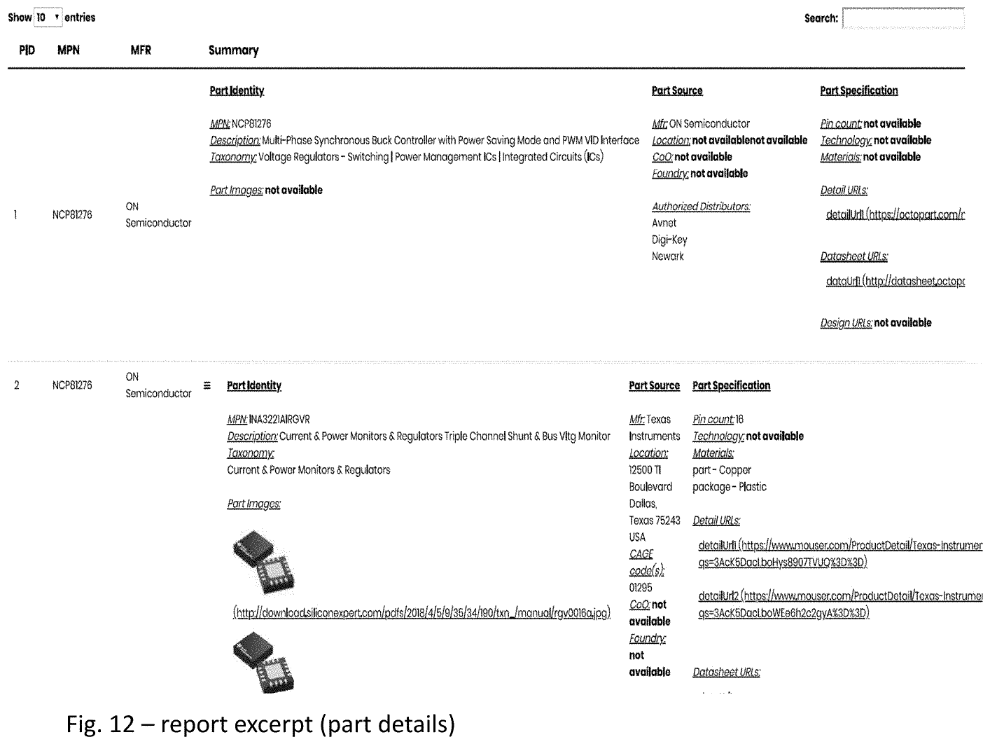

In an embodiment of the system, the automated analysis includes a display summarizing the analysis results (see FIG. 11 and FIG. 12 for example implementations).

### Manual Analysis

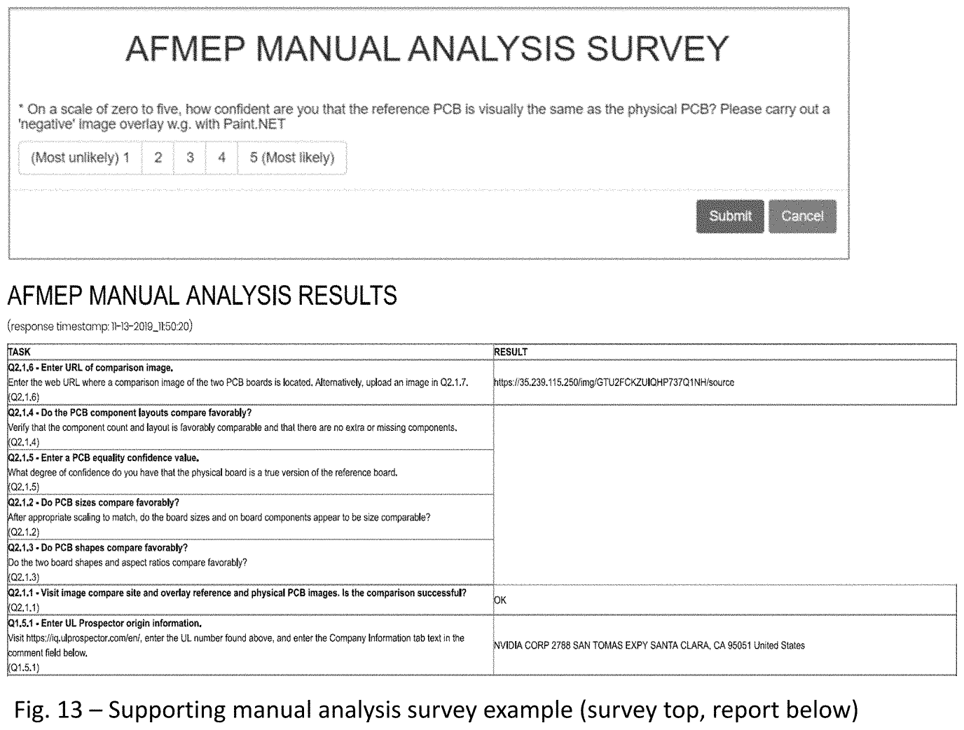

In an embodiment of the system, the invention tracks manual analysis steps carried out alongside the automated analysis: One or more users enter information at each step of the manual analysis workflow, e.g. into a survey-style implementation. At the end, the completed survey results are fed into the system and used as an additional data source analysis and/or report generation. For example, if manual analysis determines a tampered soldering spot, this may lower confidence for that part. Or, for example, if a physical overlay of the physical and reference PCB images show visual differences discernable by the human eye, this may lower confidence that the reference board is actually correct. FIG. 13 illustrates a manual survey and report (excerpts).

### Report Generation

Finally, in step 390 of FIG. 3, a report with the BOM table and all/some of the gathered information and analysis results is generated (e.g. based on user preferences). For example, the report can be a web page, e.g. one long page for printing, a page with collapsible sections etc., or a document, spreadsheet, etc., or a machine-readable report (e.g. JSON/XML).

In an embodiment of the system, the report includes one or more sections of content (also see text in step 390 in FIG. 3):
assembly information
BOM table(s) with some/all found information (e.g. from part databases, online sources etc.)
weblinks, text snippets, or full-text of relevant information
reference information, incl. pictures, documents, reference BOMs, text snippets, part data sources
weblinks or depictions of some/all images
analysis results summaries and/or details
manual analysis results
. . . .

FIG. 11 and FIG. 12 illustrate excerpts of example implementations of report sections.

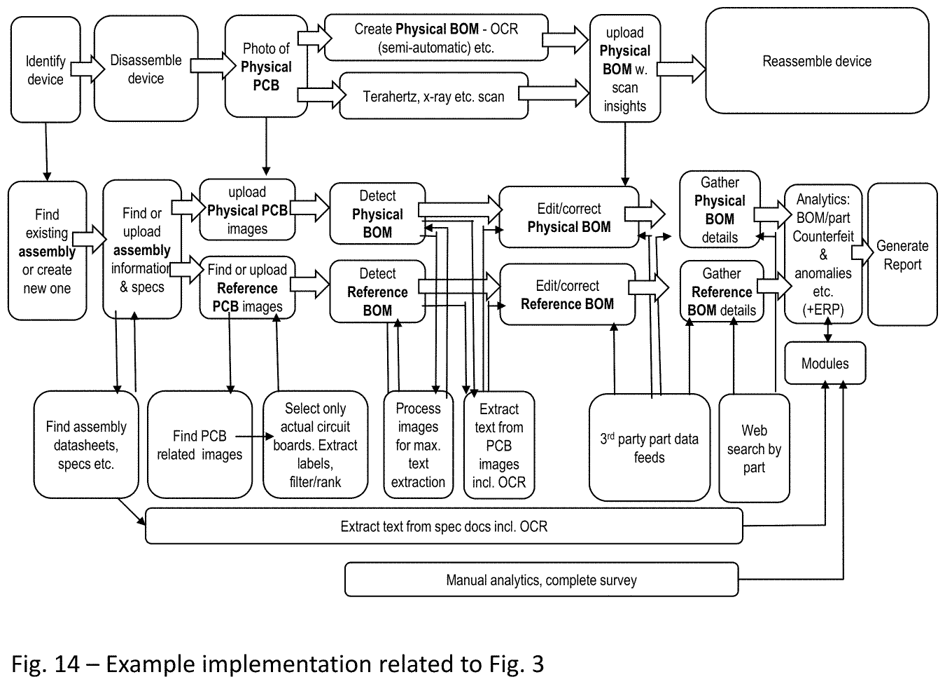

FIG. 14 shows another depiction of an embodiment of the invention in line with FIG. 3—again, note that steps can be reordered, added, or removed.

### Organization-Specific Data Analysis

In an embodiment of the system, additional more organization-specific data sources are also considered during the analysis, with the objectives to improve analysis results, populate information for the analysis etc. Examples include but are not limited to:
(1) procurement information: Procurement information provides a wealth of information about which products an organization purchased, when they were purchased, at what price, from whom, how they were shipped etc. This information—if available—is tapped into and used to populate some of the information used for the analysis, such as product information (model, make, serial number, BOM etc.), purchase requisition, purchase order, vendor, price, shipping, dates etc. Analyses to identify anomalies (counterfeit, repurposed, modified, hacked, subpar, used etc.) include but are not limited to:
(a) Price anomalies indicating item anomalies, such as statistical outliers from a pricing norm, potentially combined with other factors. For example, if none of the usual suppliers an organization buys from have a particular item, but an unusual supplier has the item at a fraction of the cost, there is an increased risk that the item is counterfeit or not new. In an embodiment, machine learning is used to learn normal/abnormal from the data, e.g. in line with the inventions described above in this specification.
(b) Vendor and shipping anomalies indicating item anomalies: For example, if a vendor always ships a particular kind of item from the same location, but one instance of the item was shipped from a different location, there is an increased risk that the item is abnormal (e.g. used). In another example, if a vendor's address registration (e.g. in the procurement system, CAGE code etc.) does not match with the shipping location, there is also an increased risk. In yet another example, if the shipping trace indicates anomalies, there is an increased risk that the shipped items have been tampered with.
(c) Component and serial numbers: Serial numbers usually follow a documented pattern for each product/manufacturer and, if not within that pattern, can indicate item anomalies.
(2) Inventory, resource planning, yield information, and manufacturing related information in general: In an embodiment of the system, this information is used to determine anomalies around suppliers and their items, for example lower yield rates of parts from one supplier compared to other suppliers, which could indicate item anomalies.
(3) Maintenance/performance/failure etc. information: In an embodiment, information about the performance of a purchased item, or items sold that include purchased components is analyzed. Information sources include issue tracking systems, product returns/recalls etc., maintenance systems (predictive, condition-based etc.), maintenance reports etc. For example, if products sold that contain components from a particular batch have a higher failure rate than sold products that contain components from other batches, then the items from that batch may be anomalous. In an embodiment of the system, these insights are further used to (potentially predictively) determine which other products are or will be affected that include components from the same anomalous batch.

It is evident that the presented invention by no means limited to analyzing microelectronics or PCBs. It can be used for any use case scenario where similarity of an item with a reference specification can be determined. For example (but not limited to):
Medical supplies: Counterfeit or substandard medical supplies are a danger to patients. Especially during pandemics, emergency medical supplies such as masks, test kits, sanitizer etc. can become scarce, and counterfeit/subpar supplies could be purchased. In this scenario, an embodiment of the system supports uploading images of medical equipment (e.g. N95 masks) and searches online for reference information, and uses object image recognition with text extraction and reputation scoring etc. as described above to determine if the text/shape/color etc. of the uploaded image(s) matches with the reference information. This way, the system will be able to flag supplies that are counterfeit based on text/shape/color etc.
Fashion items, clothing, shoes, handbags, leather goods etc.: Counterfeits in the fashion/clothing industry are a problem. In 2020, for example, Nike is the often listed as the most counterfeited brand. Often it is possibly to visually inspect and detect differences when comparing with authentic items. An embodiment of the system is directed towards automating this check by comparing with reference information, e.g. from the authentic manufacturer website.
Pharmaceuticals: Pharmaceutical substances (and chemicals in general) can be scanned using non-visual imaging, e.g. THz scanning. An embodiment of the system is directed towards allowing users to upload such scans of substances, and detecting anomalies compared to authentic substance scans (e.g. maintained by FDA etc.)
Materials: Materials often have detectable patterns (visually or non-visual scans), for example cloth, carpets, woods, metals etc. An embodiment of the system is directed towards allowing users to upload such scans of materials and detecting anomalies compared to authentic scans (e.g. automated visual comparison of furniture wood)
Packaging: Fake items can come in packaging that does not exactly resemble the authentic item packaging. An embodiment of the system is directed towards allowing users to upload such scans of packaging and detecting anomalies compared to authentic scans (e.g. automated visual comparison of product box)
Food and beverage: Food items can be highly safety-critical if tampered with or spoilt. An embodiment of the system is directed towards allowing users to upload scans of food packaging and/or food items, and detecting anomalies compared to authentic scans (e.g. manufacturer website)
Documents: An embodiment of the system is directed towards allowing users to upload scans of documents such as identification, badges, logistics documents, receipts etc., and detecting anomalies compared to authentic scans (e.g. website of the document issuer).

While the foregoing disclosure shows illustrative embodiments of the invention, it should be noted that various changes and modifications could be made herein without departing from the scope of the invention as defined by the appended claims. The functions, steps and/or actions of the method claims in accordance with the embodiments of the invention described herein need not be performed in any particular order. Furthermore, although elements of the invention may be described or claimed in the singular, the plural is contemplated unless limitation to the singular is explicitly stated.

What is claimed is:

1. A method of automating analyzing anomalies of at least one item for which no golden reference item is available, by using reference information, wherein the golden reference item is a known non-abnormal instance of an analyzed assembly, the method comprising:
loading, via a processor, from a data storage, a memory, or via a communication, or user entry, at least one item information of an analyzed item to be analyzed to be either expected or abnormal;
loading, via the processor, at least one reference information about the analyzed item;
preprocessing, via the processor, both of the at least one item information and the at least one reference information to facilitate analysis;
analyzing, via the processor, the at least one item information and the at least one reference information to determine at least one result that indicates whether elements of the at least one item are confirmed by the at least one reference information to be expected or abnormal;
generating, via the processor, an output data with the at least one result; and
storing, via the processor, the output data pertaining to the at least one result in a memory.

2. The method according to claim 1, wherein the analyzed item comprises at least one of a device, microelectronics, a printed circuit board, a medical supplies item, a fashion item, or pharmaceutical substances.

3. The method according to claim 1, wherein the at least one item information comprises at least one of a make, a model, a serial, a revision, a type, an origin, images, visual images, photographs, non-visual images, x-ray images, terahertz images, electromagnetic images, electroscopic image, specifications, datasheets, item literature, shopping reviews, counterfeit databases, item databases, shop listings, social media information, news media information, or a bill of materials.

4. The method according to claim 1, wherein loading at least one reference information comprises loading from a local storage or memory, a remote network location, or a search engine.

5. The method according to claim 1, wherein the at least one reference information comprises at least one of a make, a model, a serial, a revision, a type, an origin, images, visual images, photos, non-visual images, x-ray images, terahertz images, electromagnetic images, electroscopic image, specifications, datasheets, item literature, shopping reviews, counterfeit databases, item databases, shop listings, social media information, news media information, or a bill of materials.

6. The method according to claim 1, wherein preprocessing both of the at least one item information and the at least one reference information comprises performing one or more of Optical Character Recognition (OCR), text extraction, Natural Language Processing (NLP), image processing, computer vision, image object recognition, textual lookups, textual resolving, and textual auto-complete on both of the at least one item information and the at least one reference information or validating the accuracy of the at least one item information and the at least one reference information.

7. The method according to claim 1, wherein analyzing the at least one item information and the at least one reference information comprises determining: confidence in identification, source, specification; risk, trust and compliance levels; whether a bill of materials of the analyzed item is as expected; whether an image of the analyzed item matches with the at least one reference information; known issues with the analyzed item; known issues with the bill of materials of the analyzed item.

8. The method according to claim 1, wherein analyzing the at least one item information and the at least one reference information comprises performing automated and manual analysis on the at least one item information and the at least one reference information.

9. The method according to claim 1, wherein generating an output data with the at least one result comprises performing one or more of user interface output, report, dashboard, alarm, and notification.

10. The method according to claim 1, wherein storing an output data with the at least one result comprises storing the output data to a local memory or storage, or transmitting output data to a remote location and storing the output data to a memory at the remote location.

11. A system for automating analyzing anomalies of at least one item for which no golden reference item is available, by using reference information, wherein the golden reference item is a known non-abnormal instance of an analyzed assembly, the system comprising:
a processor that is configured to:
load, from a data storage, a memory, or via a communication, or user entry, at least one item information of an analyzed item to be analyzed to be either expected or abnormal;
load at least one reference information about the analyzed item;
preprocess both of the at least one item information and the at least one reference information to facilitate analysis;
analyze the at least one item information and the at least one reference information to determine at least one result that indicates whether elements of the at least one item are confirmed by the at least one reference information to be expected or abnormal;
generate an output data with the at least one result; and
store the output data pertaining to the at least one result in a memory.

12. The system according to claim 11, wherein the analyzed item comprises at least one of a device, microelectronics, a printed circuit board, a medical supplies item, a fashion item, or pharmaceutical substances.

13. The system according to claim 11, wherein the at least one item information comprises at least one of a make, a model, a serial, a revision, a type, an origin, images, visual images, photographs, non-visual images, x-ray images, terahertz images, electromagnetic images, electroscopic image, specifications, datasheets, item literature, shopping reviews, counterfeit databases, item databases, shop listings, social media information, news media information, or a bill of materials.

14. The system according to claim 11, wherein the at least one reference information is loaded from a local storage or memory, a remote network location, or a search engine.

15. The system according to claim 11, wherein the at least one reference information comprises at least one of a make, a model, a serial, a revision, a type, an origin, images, visual images, photos, non-visual images, x-ray images, terahertz images, electromagnetic images, electroscopic image, specifications, datasheets, item literature, shopping reviews, counterfeit databases, item databases, shop listings, social media information, news media information, or a bill of materials.

16. The system according to claim 11, wherein the processor preprocesses both of the at least one item information and the at least one reference information by performing one or more of Optical Character Recognition (OCR), text extraction, Natural Language Processing (NLP), image processing, computer vision, image object recognition, textual lookups, textual resolving, and textual auto-complete on both of the at least one item information and the at least one reference information or by validating the accuracy of the at least one item information and the at least one reference information.

17. The system according to claim 11, wherein the processor analyzes the at least one item information and the at least one reference information by determining: confidence in identification, source, specification; risk, trust and compliance levels; whether a bill of materials of the analyzed item is as expected; whether an image of the analyzed item matches with the at least one reference information; known issues with the analyzed item; known issues with the bill of materials of the analyzed item.

18. The system according to claim 11, wherein the processor analyzes the at least one item information and the at least one reference information by performing automated and manual analysis on the at least one item information and the at least one reference information.

19. The method according to claim 11, wherein the processor generates the output data with the at least one result by performing one or more of user interface output, report, dashboard, alarm, and notification.

20. The method according to claim 11, wherein the processor stores the output data with the at least one result by storing the output data to a local memory or storage, or transmitting output data to a remote location and storing the output data to a memory at the remote location.
